(19) United States
(12) Patent Application Publication
(10) Pub. No.: US 2015/0328643 A1
(43) Pub. Date: Nov. 19, 2015

(54) MEAT GRINDER WITH A HOPPER

(71) Applicant: GEA FOOD SOLUTIONS BAKEL B.V., Bakel (NL)

(72) Inventors: Harrie Van Beers, JN Budel (NL); Louis Marcelis, AJ Castenray (NL); Volker Sassmannshausen, Bad Laasphe (DE)

(73) Assignee: GEA FOOD SOLUTIONS BAKEL B.V., Bakel (NL)

(21) Appl. No.: 14/653,075

(22) PCT Filed: Dec. 13, 2013
(86) PCT No.: PCT/EP2013/076602

§ 371 Date: Jun. 17, 2015

(30) Foreign Application Priority Data
Dec. 21, 2012 (DE) 10 2012 112 925.8

(51) Int. Cl. B02C 18/22; B02C 18/30

(52) U.S. Cl. CPC B02C 18/2291; B02C 18/2258; B02C 18/305

(57) ABSTRACT

The present invention relates to a meat grinder (1) with a hopper (2), the bottom region (7) of which accommodates a conveying means (5), which transports the meat towards a cutter unit, which grinds said meat. A side wall (4) of the hopper has sections (4.1, 4.2), with a different pitch.

The present invention relates to a meat grinder with a hopper, in the base region of which is arranged a conveying means which transports the meat in the direction of a cutting unit, which comminutes the meat.

Such meat grinders are known from the prior art, but have the disadvantage that the meat which is to be comminuted forms bridges and thus does not shift onward in the direction of the conveying means. This means that there is no continuous flow of the meat in the direction of the cutting unit, and the meat grinder starts to pump.

It was therefore an object of the present invention to provide a meat grinder which does not have the disadvantages of the prior art.

The object is achieved by a meat grinder with a hopper, in the base region of which is arranged a conveying means which transports the meat in the direction of a cutting unit, which comminutes the meat, wherein the side wall of the hopper, in the base region, has portions with different gradients.

The present invention relates to a meat grinder which comminutes, for example, lumps of meat into minced meat or the like. For this purpose, the meat grinder has a cutting unit, for example a perforated plate, with a rotating blade. The meat is conveyed by a conveying means, for example a screw conveyor, in the direction of the cutting unit and comminuted there. The conveying means rotates preferably about an essentially horizontally arranged axis of rotation. The conveying means usually also drives the blade. According to the invention, the conveying means is arranged in the base region of a hopper, which preferably has an essentially rectangular cross section. Also according to the invention, the hopper has a base region adjoined to the right and left in each case by a side wall of the hopper. The base region is preferably curved in the form of a circle segment, wherein the radius of the curve corresponds at least essentially to the radius of the conveying means, in particular of a screw conveyor. A side wall of the hopper, in the base region, has portions with different gradients. The side wall extends parallel to the axis of rotation of the conveying means. The different gradients of the side wall make it possible to provide a cavity, to the side of the conveying means, which is, for example, triangular or trapezoidal and into which the meat which is to be comminuted can shift easily. From there, the conveying means takes hold of the meat and conveys it in the direction of the cutting unit.

The two portions of the side wall are preferably linear, i.e. are not curved, in particular are not rounded, and therefore they do not follow the circumference of a screw conveyor with a circular cross section.

The gradient of the lower portion relative to the horizontal is preferably smaller than the gradient of the upper portion relative to the horizontal. This gives an essentially trapezoidal cavity, between the side wall and the screw conveyor, into which the meat can shift onward in the direction of the screw conveyor.

A further or preferred subject matter of the present invention is a meat grinder with a hopper, in the base region of which is arranged a conveying means which transports the meat in the direction of the cutting unit, which comminutes the meat, wherein the base region partially encloses the cross section of the conveying means and the angle of enclosure is not more than 120°, preferably less than 110°, particularly preferably less than 100°, and the angle of wrap should not fall below a value of 80°, preferably 85°.

The small angle of enclosure gives rise, at least on one side, to a cavity, between the screw conveyor and the side wall of the hopper, into which meat, which is conveyed by the conveying means in the direction of the cutting unit, can shift onward without forming bridges.

An introduction region is preferably located upstream of the hopper and, as seen in relation to the flow direction of the meat, has a larger cross section than the largest cross section of the hopper.

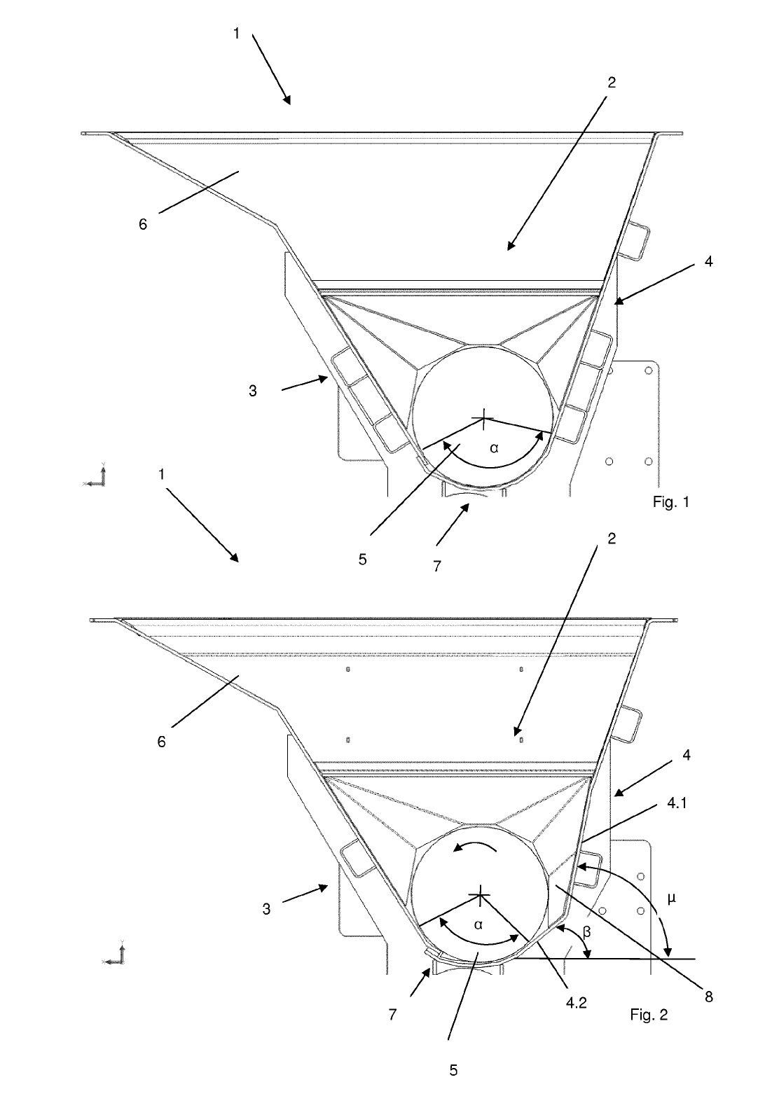

The invention will be explained herein below with reference to FIGS. 1 and 2. These explanations are provided merely by way of example and do not limit the general concept of the invention. The explanations apply equally to all the inventions. It the figures:

FIG. 1 shows a meat grinder according to the prior art, and

FIG. 2 shows the meat grinder according to the invention.

FIG. 1 shows a meat grinder according to the prior art. The meat which is to be comminuted is introduced into an introduction region 6, from which it descends into a hopper 2. This hopper 2 has a base region 7, in which is located a conveying means 5 which extends in, and away from, the plane of the paper. The meat which is to be comminuted is conveyed by said conveying means in the direction of a cutting unit (not illustrated), for example of a blade/perforated-plate combination, which comminutes the meat. The base region 7 is adjoined to the right and left by the side walls 3 and 4 of the hopper, said side walls extending parallel to the center axis of the conveying means 5. In the present case, the base region 7 and/or the side walls are/is configured such that the base region wraps around the conveying means, in this case a screw conveyor, over an angle of wrap of at least 145°. This angle and the angle of the side walls give rise to the formation, within the hopper, of bridges which prevent the meat which is to be comminuted from flowing uniformly in the direction of the conveying means.

This problem is solved according to the invention by a hopper according to FIG. 2, reference being made to what has been said in relation to FIG. 1. In the case of this hopper, the side wall 4 has two regions 4.1 and 4.2, the angle β between a horizontal and the lower portion 4.2 being smaller than the angle μ between the horizontal and the upper portion 4.1. This gives rise to a significantly smaller angle of wrap α, which in the present case is between 91° and 95°. Furthermore, the lower portion 4.2 and the upper portion 4.1 are of linear design and the lower portion is configured over its length, in a direction perpendicular to the direction of extent of the conveying means, such that a cavity which is filled by the meat which is to be comminuted is formed alongside the conveying means, in this case the screw conveyor, in particular level with the center axis thereof and beneath the same, in the direction of the base region. This means that there is always meat located in the region of the conveying means, and there is therefore a continuous flow in the direction of the cutting unit. The direction of rotation of the conveying means is identified by an arrow.

### LIST OF DESIGNATIONS

1 Meat grinder

2 Hopper

3 First side wall of the hopper

4 Second side wall of the hopper

4.1 Upper portion of the second side wall of the hopper

4.2 Lower portion of the second side wall of the hopper

5 Conveying means, screw conveyor

6 Introduction region

7 Base region

8 Cavity

α Angle of wrap

β Gradient of the lower portion

μ Gradient of the upper portion

What is claimed is:

1. A meat grinder comprising:
a hopper including a base region,
a conveying means located within the base region of the hopper, which transports the meat in the direction of a cutting unit, which comminutes the meat, and the conveying means includes a side wall;
wherein the side wall partially encloses a cross section of the conveying means;
wherein an angle of enclosure is always less than 110°, the side wall of the hopper as portions with different gradients, and the portions are linear.

2. (canceled)

3. The meat grinder as claim 1, wherein the portions have a lower portion and an upper portion and the gradient of the tower portion is smaller than the gradient of the upper portion.

4. The meat grinder as claimed in claim 1, wherein the conveying means is a screw conveyor.

5. (canceled)

6. The meat grinder as claimed in claim 1, wherein an introduction region is located upstream of the hopper.

7. The meat grinder as claimed in claim 3, wherein the conveying means is a screw conveyor.

8. The meat grinder as claimed in claim 7, wherein an introduction region is located upstream of the hopper.

9. The meat grinder as claimed in claim 1, wherein the different gradients of the side walls from a cavity.

10. The meat grinder as claimed in claim 9, wherein the cavity is triangular or trapezoidal in shape so that meat can shift within the cavity.

11. The meat grinder as claimed in claim 9, wherein the cavity formed between the side wall and the conveying means is essentially trapezoidal in shape.
